(19) United States
(12) Patent Application Publication
(10) Pub. No.: US 2024/0161021 A1
(43) Pub. Date: May 16, 2024

(54) AI LAND DISCOVERY FOR POTENTIAL CROP GROWING

(71) Applicant: INTERNATIONAL BUSINESS MACHINES CORPORATION, ARMONK, NY (US)

(72) Inventors: Saraswathi Sailaja Perumalla, Visakhapatnam (IN); Sarbajit K. Rakshit, Kolkata (IN); Venkata Ratnam Alubelli, Visakhapatnam (IN)

(21) Appl. No.: 18/055,263

(22) Filed: Nov. 14, 2022

(51) Int. Cl. G06Q 10/04; G06Q 10/06

(52) U.S. Cl. CPC G06Q 10/04; G06Q 10/0635

(57) ABSTRACT

A method is provided for AI land discovery for potential crop growing that includes extracting features from imaging of a geographic area. Underutilized or unutilized land is identified within the geographic area based on the extracted features. Multimedia is analysed related to climatic conditions affecting the underutilized or unutilized land. At least one robot is deployed to obtain local measurements at the identified underutilized or unutilized land. Crop growth viability is evaluated for at least one crop at the underutilized or unutilized land. The crop growth viability includes the analysed climatic conditions and obtained local measurements. The cultivation of the at least one crop is implemented.

### BACKGROUND

Exemplary embodiments of the present inventive concept relate to crop growing, and more particularly, to artificial intelligence (AI) land discovery for potential crop growing.

As human population increases at an exponential pace, there is an increasing strain on global food supply despite the concomitant encroachment/interspersal of cities on farmable land. There is a constant need to find more land to cultivate this food supply which is not necessarily contiguous. In addition, farming has become less intuitive and involves thinner margins of profit while farming as a profession has decreased in popularity. The identification of vacant land and its suitability for cultivation has been elusive.

### SUMMARY

Exemplary embodiments of the present inventive concept relate to a method, a computer program product, and a system for AI land discovery for potential crop growing.

According to an exemplary embodiment of the present inventive concept, a method is provided for AI land discovery for potential crop growing that includes extracting features from imaging of a geographic area. Underutilized or unutilized land is identified within the geographic area based on the extracted features. Multimedia is analysed related to climatic conditions affecting the underutilized or unutilized land. At least one robot is deployed to obtain local measurements at the identified underutilized or unutilized land. Crop growth viability is evaluated for at least one crop at the underutilized or unutilized land. The crop growth viability includes the analysed climatic conditions and obtained local measurements. The cultivation of the at least one crop is implemented.

According to an exemplary embodiment of the present inventive concept, a computer program product is provided for AI land discovery for potential crop growing. The computer program product includes one or more computer-readable storage media and program instructions stored on the one or more non-transitory computer-readable storage media capable of performing a method. The method includes extracting features from imaging of a geographic area. Underutilized or unutilized land is identified within the geographic area based on the extracted features. Multimedia is analysed related to climatic conditions affecting the underutilized or unutilized land. At least one robot is deployed to obtain local measurements at the identified underutilized or unutilized land. Crop growth viability is evaluated for at least one crop at the underutilized or unutilized land. The crop growth viability includes the analysed climatic conditions and obtained local measurements. The cultivation of the at least one crop is implemented.

According to an exemplary embodiment of the present inventive concept, a computer system is provided for AI land discovery for potential crop growing. The system includes one or more computer processors, one or more computer-readable storage media, and program instructions stored on the one or more of the computer-readable storage media for execution by at least one of the one or more processors capable of performing a method. The method includes extracting features from imaging of a geographic area. Underutilized or unutilized land is identified within the geographic area based on the extracted features. Multimedia is analysed related to climatic conditions affecting the underutilized or unutilized land. At least one robot is deployed to obtain local measurements at the identified underutilized or unutilized land. Crop growth viability is evaluated for at least one crop at the underutilized or unutilized land. The crop growth viability includes the analysed climatic conditions and obtained local measurements. The cultivation of the at least one crop is implemented.

### BRIEF DESCRIPTION OF THE DRAWINGS

The following detailed description, given by way of example and not intended to limit the exemplary embodiments solely thereto, will best be appreciated in conjunction with the accompanying drawings, in which:

FIG. 1 illustrates a schematic diagram of computing environment 100, which may include AI land discovery for potential crop growing program 150, in accordance with an exemplary embodiment of the present inventive concept.

FIG. 2 illustrates a flowchart of AI land discovery for potential crop growing 200, in accordance with an exemplary embodiment of the present inventive concept.

It is to be understood that the included drawings are not necessarily drawn to scale/proportion. The included drawings are merely schematic examples to assist in understanding of the present inventive concept and are not intended to portray fixed parameters. In the drawings, like numbering may represent like elements.

### DETAILED DESCRIPTION

Exemplary embodiments of the present inventive concept are disclosed hereafter. However, it shall be understood that the scope of the present inventive concept is dictated by the claims. The disclosed exemplary embodiments are merely illustrative of the claimed system, method, and computer program product. The present inventive concept may be embodied in many different forms and should not be construed as limited to only the exemplary embodiments set forth herein. Rather, these included exemplary embodiments are provided for completeness of disclosure and to facilitate an understanding to those skilled in the art. In the detailed description, discussion of well-known features and techniques may be omitted to avoid unnecessarily obscuring the presented exemplary embodiments.

References in the specification to “one embodiment,” “an embodiment,” “an exemplary embodiment,” etc., indicate that the embodiment described may include a particular feature, structure, or characteristic, but not every embodiment may necessarily include that feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether explicitly described.

In the interest of not obscuring the presentation of the exemplary embodiments of the present inventive concept, in the following detailed description, some processing steps or operations that are known in the art may have been combined for presentation and for illustration purposes, and in some instances, may have not been described in detail. Additionally, some processing steps or operations that are known in the art may not be described at all. The following detailed description is focused on the distinctive features or elements of the present inventive concept according to various exemplary embodiments.

There is a need to discover potential land for crop growing and analyse crop cultivation suitability. The present inventive concept leverages AI to autonomously scour imaging for potential land for crop growing and analyse data gathered on local environmental conditions and measurements to simulate the viability of these potential lands for crop cultivation.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as AI land discovery for potential crop growing program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

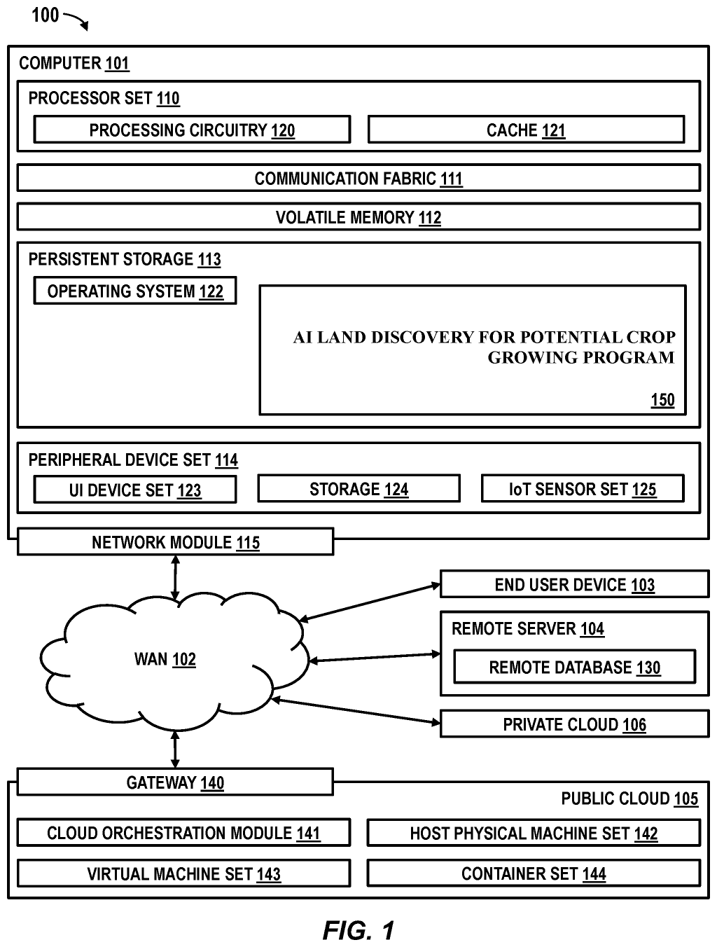

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

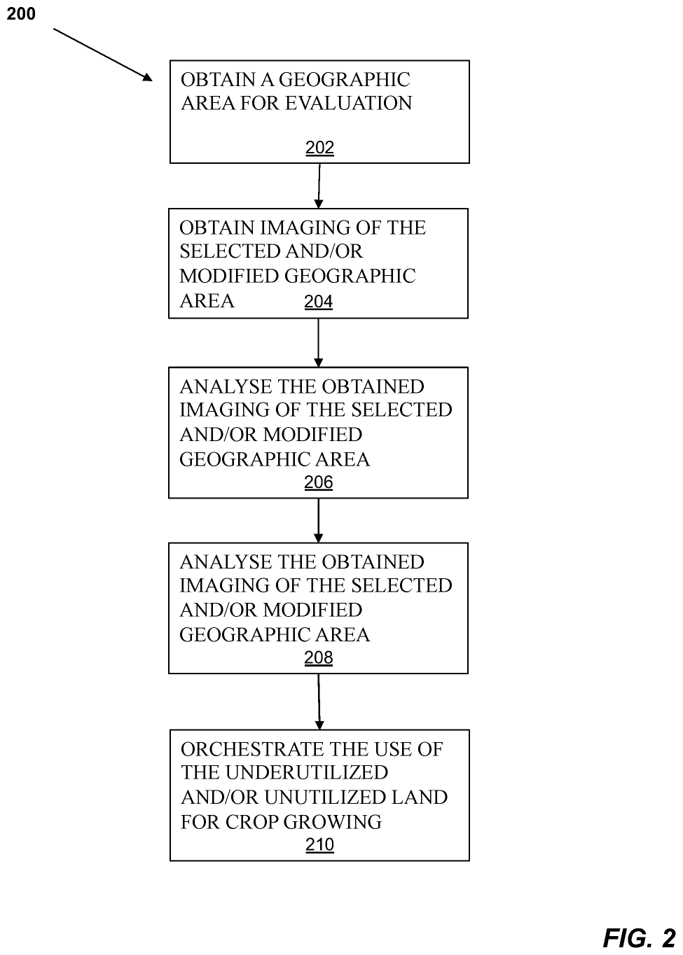

FIG. 2 illustrates a flowchart of AI land discovery for potential crop growing 200, in accordance with an exemplary embodiment of the present inventive concept.

The AI land discovery for potential crop growing program 150 may obtain a geographic area for evaluation (step 202). The user may explicitly select the geographic area (e.g., by identifier, GPS coordinates, radius from a specified locus, and/or custom area on a virtual map, etc.). Alternatively, the AI land discovery for potential crop growing program 150 may select the geographic area and/or modify (e.g., refine, narrow, broaden, etc.) the user selected geographic area based on prior learning (land previously analysed via AI land discovery for potential crop growing 200), a registry of land available for lease and/or sale (e.g., farmland), and/or according to user input parameters (e.g., thresholds, requisite features, ranges, etc.). The user input parameters for the geographic area may include climatic conditions (atmospheric moisture, sunlight, temperature, pollution levels, carbon dioxide levels, etc.), local weather (e.g., variable wind, rain, sunlight, etc.), elevation, maximum/minimum population, size (e.g., square footage), estimated land lease and/or sale cost, distance from a designated point (e.g., smart city, highways, roads, water bodies, merchants, warehouses, protected land, etc.), and/or selected crops (e.g., requisite climatic conditions, desired crop yield, crop loss risk tolerance, etc.). The geographic area may refer to an area with delineated boundaries (e.g., state, county, city, town, village, parcel, survey, custom area, etc.) and/or randomized locations within the geographic area. The geographic area may include contiguous and/or non-contiguous land. Data related to the user input parameters may be entered by the user or extracted from multimedia (e.g., video, text, audio, animations, etc.) obtained via a network (e.g., websites, forums, databases, etc.) by machine learning processes (e.g., computer vision, natural language processing (NLP), automatic speech recognition (ASR), etc.). The AI land discovery for potential crop growing program 150 may annotate a virtual map with the data related to the user input parameters and the calculations that form any basis for selection and/or modification of the geographic area.

For example, a user selects a geographic area using a lasso tool on a virtual map interface of the AI land discovery for potential crop growing program 150. In addition, the user input parameters include less than 25 miles from Smart City; blueberries, apples, and oranges as selected crops; and crop loss risk of under 25%. The AI land discovery for potential crop growing program 150 retrieves multimedia from the web regarding requisite crop growing conditions for the selected crops as well as climatic and weather conditions for the user selected area. A mountain range on the outskirts of the city has a windward side facing away from Smart City at 15 miles away. The land which is 15-18 miles from Smart City is determined by the AI land discovery for potential crop growing program to have the greatest precipitation. However, the land from 15-17 miles from Smart City has a steep elevation causing lower temperatures, more challenged access, and more cloud cover. Thus, mile 18 is selected as a modified geographic area. However, no conditions exist in the geographic area before or after modification that will permit oranges to be grown at less than a 25% crop loss risk due to rapid onset of cold temperatures in the late Fall. The AI land discovery for potential crop growing program 150 annotates the virtual map and displays the modified geographic area to the user.

The AI land discovery for potential crop growing program 150 may obtain imaging of the selected and/or modified geographic area (step 204). The AI land discovery for potential crop growing program 150 may obtain imaging of the selected and/or modified geographic area using satellite imaging, IoT video, pictures, etc. The imaging of the selected and/or modified geographic area may be obtained, for example, by a local and/or deployed robot, autonomously over the network (e.g., streamed, downloaded, etc.), and/or by user upload. In the case of robot obtained imaging, at least one robot may be programmed to autonomously obtain the imaging of the selected and/or modified geographic area and transmit the same to the AI land discovery for potential crop growing program 150. The at least one robot may be flight capable, off-road capable, water capable, stationary, etc. In the case of a plurality of robots, the AI land discovery for potential crop growing program 150 may delegate roles and areas to survey to each of the plurality of robots. The AI land discovery for potential crop growing program 150 and/or the at least one robot may be further connected to a smart city network. The smart city network may include a plurality of robots belonging to the same or different users. In the case of imaging obtained autonomously over the network, the AI land discovery for potential crop growing program 150 may perform a targeted word search of the selected and/or modified geographic area (e.g., name and/or encompassing area, GPS coordinates, included neighbourhoods, adjacent landmarks, etc.) of the web (e.g., databases, websites, connected computing devices, etc.) for visual multimedia (e.g., images, animations, and/or videos).

For example, the AI land discovery for potential crop growing program 150 deploys a fleet of flight capable robots to survey the modified geographic area and obtain imaging using GPS. The AI land discovery for potential crop growing program 150 virtually carves up the modified geographic area into zones and assigns flight capable robots to respective zones. Additionally, the AI land discovery for potential crop growing program 150 obtains satellite imaging of the modified geographic area via the network by searching for the encompassing town and magnifying accordingly.

The AI land discovery for potential crop growing program 150 may analyse the obtained imaging of the selected and/or modified geographic area (step 206). The AI land discovery for potential crop growing program 150 may identify features in the obtained imaging using machine learning analysis (e.g., computer vision, NLP, etc.) and designate land within the selected and/or modified geographic area as underutilized, unutilized, or utilized. The identified features may include pedestrian features (e.g., pedestrians, hunting attire, employer uniforms, etc.), vehicle features (e.g., vehicles, tire tracks, identities thereof, etc.), manmade features, natural features, and signage features.

The identified manmade features may include manmade structures, such as residential neighbourhoods, residential homes, office parks, commercial buildings, utility plants, utility structures (e.g., transmission towers, light poles, water towers, energy plants, wind turbines, sewage treatment plants, etc.), roadways (e.g., bridges, streets, highways, interstates, dirt roads, etc.), pedestrian walkways, greenhouses, etc. The AI land discovery for potential crop growing program 150 may also identify characteristics of the manmade features (e.g., dimensions, types, materials, addresses, distances, and relationships to other identified features, etc.), qualitative conditions (e.g., estimated age, dilapidated versus intact, vegetation growth, etc.), and/or quantity (e.g., concentrations of manmade structures) thereof.

The natural features may include topography, such as forested areas, trees, grassy open areas, water bodies (e.g., puddles, streams, ponds, lakes, etc.), rock formations (e.g., boulders, cliffs, rock gardens, etc.), evidence of existent crop farming (e.g., adjacent farming apparatuses, crop arrays, etc.), and/or elevations (e.g., hills, mountains, cliffs, grades, etc.). The AI land discovery for potential crop growing program 150 may also identify characteristics of the natural features (e.g., dimensions, types, addresses, GPS coordinates, distances, and relationships to other identified features, etc.), qualitative conditions (e.g., deteriorating fauna, barren dirt, sparse vegetation, deforestation, forest fire charring, flooding, acid rain damage, pest/disease, etc.) and/or quantity (e.g., concentrations of natural features) thereof.

The signage features may include zoning restrictions; condemnation; imminent construction (e.g., advertised permits); expressed ownership (private, public, government owned, entity owned, individual owned, etc.); company/government emblems and/or logos; protected land status; and/or warnings (e.g., no trespassing, contamination, falling rocks, predatory animals, hunting season, etc.); etc. The signage features may further include any posted dates in determining continued significance as well as any means of contact (e.g., phone numbers).

The AI land discovery for potential crop growing program 150 may designate land within the selected and/or modified geographic area as utilized, unutilized, or underutilized based on the analysed imaging. The AI land discovery for potential crop growing program 150 may make these designations according to the identified features, such as signage features; density of manmade and/or natural features and identities thereof; comparative density of manmade versus natural features; relative sizes of identified features; continuity and/or contiguousness of manmade and/or natural features; pedestrian and/or vehicle traffic; etc.

For example, the AI land discovery for potential crop growing program 150 analyses the obtained satellite and robot imaging of the modified geographic area and identify features therein. The identified features include office buildings in an industrial complex and nearby residential homes in a residential area; a steeply graded grassy strip with transmission towers and recreational dirt bike and truck tire tracks; and a densely forested area with a nearby lake and a large grassy field with numerous dilapidated manmade structures. The AI land discovery for potential crop growing program 150 may designate the densely forested area as unutilized despite the numerous dilapidated structures within the large grassy field. The AI land discovery for potential crop growing program 150 may designate the steeply graded grassy strip with transmission towers as underutilized. The AI land discovery for potential crop growing program 150 may designate the industrial complex and nearby residential area as utilized land.

The AI land discovery for potential crop growing program 150 may evaluate the viability of the designated underutilized and/or unutilized land for crop growing (step 208). The AI land discovery for potential crop growing program 150 may obtain measurements from the underutilized and/or unutilized land, including soil characteristics (e.g., nitrogen levels, moisture levels, pollutant content, etc.), lake water purity (e.g., pollutant levels), sunlight exposure, and/or ambient air characteristics (carbon dioxide levels, pollutant content, moisture, etc.). Measurements may be obtained by robots and/or user input. In an embodiment, sunlight exposure may be measured from the prior obtained satellite imaging. The AI land discovery for potential crop growing program 150 may suggest crops to grow according to the extracted imaging features, measurements (e.g., in ranked order of viability and/or profit), climatic conditions, etc. If the user has preselected crops, the AI land discovery for potential crop growing program 150 may determine deficits between any requisite crop growing climatic conditions and the measured local climatic conditions.

The AI land discovery for potential crop growing program 150 may evaluate the impact of identified hindrances to crop growing (e.g., boulders, debris, vehicle and/or pedestrian paths, barren land, over/under saturated soil, flood risk, dilapidated structures, air and/or soil pollutants, evidence of vehicle traffic, etc.) and, if possible, propose potential modifications to the underutilized and/or unutilized land (e.g., drainage, clearing debris and/or physical obstacles, demolishing dilapidated manmade structures, irrigating an area, curing unauthorized vehicle and/or pedestrian traffic, erecting structures, etc.). The AI land discovery for potential crop growing program 150 may predict costs associated with the potential modifications. The user may input a predicted expense threshold for potential modifications. The AI land discovery for potential crop growing program 150 may also predict and/or retrieve via the network the costs of leasing and/or purchasing the underutilized and/or utilized land (e.g., comparable land sales, property taxes, location, etc.) and/or contact an owner indicated in extracted signage features for the same. In an embodiment, the AI land discovery for potential crop growing program 150 may perform crop yield and/or cost simulations based on pre and/or post modifications. Cost/profit of incremental modifications above the minimum modifications and/or requisite conditions may be calculated and presented to the user.

For example, the user may input a desired profit of $30,000/year and an expense threshold of $50,000 for any potential modifications. The AI land discovery for potential crop growing program 150 may evaluate the viability of each designated underutilized and utilized land portion from identified features and deployed robot obtained measurements. The grassy strip is graded, which has caused image identified flooding at the bottom and excessive robot measured saturation above. The unauthorized recreational dirt bike traffic can be avoided with garden enclosures at a minimal cost of $3,000, but the truck tracks signifying potential authorized service vehicles cannot be excluded from the area, thus preventing use of the lateral portions of the grassy strip and further decreasing viable land to the land between consecutive transmission towers. The AI land discovery for potential crop growing program 150 may determine that the projected profit is only $10,000/year, and thus is not viable for crop growing. The AI land discovery for potential crop growing program 150 determines that the interior of the densely forested area is fertile according to robot taken measurements. However, it will cost $80,000 to clear and build access roads for an area proportionate to a $30,000 profit, thus it is not viable. However, the large grassy field within the densely forested area with numerous dilapidated manmade structures is determined to be potentially viable for crop growing with a projected profit of $40,000/year. Climatic measurements obtained locally satisfy the requisite growing conditions for blueberries, and apples, but the measured soil is sub-optimally dry. However, the AI land discovery for potential crop growing program 150 determines that an irrigation system connected to the adjacent lake or a lake-based hydroponic system can be installed at a cost of $30,000 each. The robot measured water quality meets requisite thresholds. In addition, the dilapidated buildings can be demolished, and the rubble hauled off for a cost of $20,000. Alternatively, the intact roofs of the dilapidated buildings may be used for crop growing at no cost.

The AI land discovery for potential crop growing program 150 may orchestrate the use of the underutilized and/or unutilized land for crop growing (step 210). The AI land discovery for potential crop growing program 150 may determine the logistics of the use of the underutilized and/or unutilized land for crop growing, including cultivation and/or implementing any required modifications. The AI land discovery for potential crop growing program 150 may implement the crop growing (e.g., tilling, seeding, watering, planting, harvesting, etc.) and/or modifications using the robots (e.g., deployed robots and/or enlist contractors for the same (e.g., directly contract, suggest to user, solicit bids, etc.). Maximal use of the underutilized and/or unutilized land may be determined based on identified features, modifications, measured local conditions, prior training, and/or the analysed data related to requisite crop conditions. The AI land discovery for potential crop growing program 150 may determine a minimum distance between adjacent crops, optimal intra-land positions for each crop, at least one array type, and/or the greatest crop yield possible given the determined minimum modifications for viability and obtained measurements. The AI land discovery for potential crop growing program 150 may monitor crop growth and/or coordinate harvest based on the analysed data on requisite crop growth.

Based on the foregoing, a computer system, method, and computer program product have been disclosed. However, numerous modifications, additions, and substitutions can be made without deviating from the scope of the exemplary embodiments of the present inventive concept. Therefore, the exemplary embodiments of the present inventive concept have been disclosed by way of example and not by limitation.

1. A method for AI land discovery for potential crop growing is provided, the method comprising:
extracting features from imaging of a geographic area;
identifying underutilized or unutilized land within the geographic area based on the extracted features;
analysing multimedia related to climatic conditions affecting the underutilized or unutilized land;
deploying at least one robot to obtain local measurements at the identified underutilized or unutilized land;
evaluating crop growth viability for at least one crop at the underutilized or unutilized land, wherein the crop growth viability includes the analysed climatic conditions and obtained local measurements; and
implementing the cultivation of the at least one crop.

2. The method of claim 1, wherein the extracting features from the imaging of the geographic area includes identifying any manmade features, natural features, and signage features.

3. The method of claim 2, wherein the imaging includes satellite imaging of the geographic area.

4. The method of claim 1, wherein the local measurements obtained by the at least one deployed robot at the identified underutilized or unutilized land includes soil quality.

5. The method of claim 1, wherein the evaluating crop growth viability for the at least one crop at the underutilized or unutilized land is based at least in part on requisite crop growing conditions for the at least one crop.

6. The method of claim 5, further comprising:
determining modifications to the underutilized or unutilized land in order to meet at least one of the requisite growing conditions and a stipulated minimum profit for a periodic crop yield.

7. The method of claim 6, wherein the implementing the cultivation of the at least one crop includes instructions to the at least one robot to perform at least one of the determined modifications, tilling, planting, and harvesting.

8. A computer program product for AI land discovery for potential crop growing, the computer program product comprising:
one or more computer-readable storage media and program instructions stored on the one or more non-transitory computer-readable storage media capable of performing a method, the method comprising:
extracting features from imaging of a geographic area;
identifying underutilized or unutilized land within the geographic area based on the extracted features;
analysing multimedia related to climatic conditions affecting the underutilized or unutilized land;
deploying at least one robot to obtain local measurements at the identified underutilized or unutilized land;
evaluating crop growth viability for at least one crop at the underutilized or unutilized land, wherein the crop growth viability includes the analysed climatic conditions and obtained local measurements; and
implementing the cultivation of the at least one crop.

9. The method of claim 8, wherein the extracting features from the imaging of the geographic area includes identifying any manmade features, natural features, and signage features.

10. The method of claim 9, wherein the imaging includes satellite imaging of the geographic area.

11. The method of claim 8, wherein the local measurements obtained by the at least one deployed robot at the identified underutilized or unutilized land includes soil quality.

12. The method of claim 8, wherein the evaluating crop growth viability for the at least one crop at the underutilized or unutilized land is based at least in part on requisite crop growing conditions for the at least one crop.

13. The method of claim 12, further comprising:
determining modifications to the underutilized or unutilized land in order to meet at least one of the requisite growing conditions and a stipulated minimum profit for a periodic crop yield.

14. The method of claim 13, wherein the implementing the cultivation of the at least one crop includes instructions to the at least one robot to perform at least one of the determined modifications, tilling, planting, and harvesting.

15. A computer system for AI land discovery for potential crop growing, the system comprising:
one or more computer processors, one or more computer-readable storage media, and program instructions stored on the one or more of the computer-readable storage media for execution by at least one of the one or more processors capable of performing a method, the method comprising:
extracting features from imaging of a geographic area;
identifying underutilized or unutilized land within the geographic area based on the extracted features;
analysing multimedia related to climatic conditions affecting the underutilized or unutilized land;
deploying at least one robot to obtain local measurements at the identified underutilized or unutilized land;
evaluating crop growth viability for at least one crop at the underutilized or unutilized land, wherein the crop growth viability includes the analysed climatic conditions and obtained local measurements; and
implementing the cultivation of the at least one crop.

16. The method of claim 15, wherein the extracting features from the imaging of the geographic area includes identifying any manmade features, natural features, and signage features.

17. The method of claim 16, wherein the imaging includes satellite imaging of the geographic area.

18. The method of claim 15, wherein the local measurements obtained by the at least one deployed robot at the identified underutilized or unutilized land includes soil quality.

19. The method of claim 15, wherein the evaluating crop growth viability for the at least one crop at the underutilized or unutilized land is based at least in part on requisite crop growing conditions for the at least one crop.

20. The method of claim 19, further comprising:
determining modifications to the underutilized or unutilized land in order to meet at least one of the requisite growing conditions and a stipulated minimum profit for a periodic crop yield.
